(19) United States
(12) Patent Application Publication
(10) Pub. No.: US 2021/0362143 A1
(43) Pub. Date: Nov. 25, 2021

(54) System and Method for Solid Catalyst Separation In Slurry Reactors

(71) Applicant: Cenovus Energy Inc., Calgary (CA)

(72) Inventors: Reza MALEK ABBASLOU, Calgary (CA); Ronald Scott SMITH, Calgary (CA)

(73) Assignee: Cenovus Energy Inc., Calgary, AB (CA)

(21) Appl. No.: 17/303,047

(22) Filed: May 19, 2021

Related U.S. Application Data
(60) Provisional application No. 63/027,585, filed on May 20, 2020.

(51) Int. Cl. B01J 38/60; B01J 38/64; B01J 10/00; B01J 19/00; B01J 19/24; C10G 47/26; B01D 17/02; B01D 21/02

(52) U.S. Cl. CPC B01J 38/60; B01J 38/64; B01J 10/002; B01J 19/0013; B01J 19/2465; C10G 2300/1044; B01D 17/0214; B01D 21/10; B01J 2219/00162; C10G 2300/701; C10G 47/26

(57) ABSTRACT

A system and method for processing a treated feed slurry produced by a slurry reactor. The method and system include mixing a chemical separation feed with the treated feed slurry produced by the slurry reactor to chemically separate solid catalyst particles in the treated feed slurry by dissolving the solid catalyst particles using an acid or base in the chemical separation feed. A heavy oil upgrading process that includes the system and method is also described.

### CROSS-REFERENCE TO RELATED APPLICATIONS

This application claims priority to U.S. Provisional Patent Application No. 63/027,585 filed on May 20, 2020, entitled “System and Method for Solid Catalyst Separation In Slurry Reactors” and the entire contents of which is incorporated herein by reference.

### TECHNICAL FIELD

The following relates to systems and methods for solid catalyst separation, in particular for slurry reactors such as hydrocracking reactors.

### BACKGROUND

Bitumen, heavy oil or extra-heavy oil, collectively referred to herein as “heavy oil”, have a high viscosity and density, and thus are treated prior to being transported by pipeline. Heavy oil can be treated by adding a diluent to reduce the viscosity and density to a value that meets certain pipeline requirements. A significant amount of diluent may be required per volume of heavy oil, thus taking up corresponding pipeline capacity. Diluent is also separated at the receiving end, requiring additional capital cost and adding complexity to the treatment process.

Heavy oil feedstock can also be upgraded to synthetic crude oil, which can be processed directly in refineries. One process for upgrading heavy oil involves the addition of hydrogen, which reduces the molecular weight of the heavy oil and increases the hydrogen-to-carbon ratio. Improving the hydrogen-to-carbon ratio can also be achieved by a carbon rejection process (e.g., coking and de-asphalting the heavy oil).

Hydrogen addition processes include hydrocracking in the presence of a suitable catalyst. The catalyst is used to activate the added hydrogen and suppress the formation of gases and coke. The hydrogen addition processes typically utilize catalysts formulated from metals and the catalysts are tailored for selective conversion and high activity to maximize process throughput and output quality. Managing the use of catalysts in hydrocracking processes can affect which reactor type is used. The two main types of reactors are referred to as fixed bed reactors and slurry reactors. Several types of slurry reactors can be used, such as stirred tank reactors and bubble column and ebullated bed reactors.

Dispersed catalysts have been used in slurry reactors. These dispersed catalysts are colloidal suspensions of nanosized catalytic particles. In practice, a slurry that includes the heavy oil and finely dispersed catalyst is fed into a hydrocracking reactor. The high density of available reaction sites can avoid the plugging of pores that cause deactivation of the catalyst, however, maintaining uniform dispersion of the catalyst particles can be challenging and this process has typically been limited to hydrogen mixing in bubble column and ebullated bed reactors.

There are a few challenges for catalyst separation and solid handling after the slurry product exits a hydrocracking reactor. One challenge is the presence of solids in the product stream that can cause severe erosion in the pressure letdown system, for example, slurry pressure valves.

Another challenge is that the separation of solids from the product slurry typically requires expensive and labor-intensive processes such as filtration, centrifugation, or settling, all of which have challenges when faced with fine or ultrafine particles that may be present in a catalyst mixture. Moreover, the solid content specifications for crude oil being transported by pipeline is relatively low, e.g., 0.5 wt %. As such, a polishing step to remove fine particles may be required, further adding to the complexity and costs associated with the system.

Yet another challenge is that the separated catalyst particles can carry and entrain 10-80% of the treated oil, resulting in significant yield loss. Additionally, catalyst wash equipment should be used, further adding to the costs associated with the system.

### SUMMARY

The following system and method address certain challenges in upgrading heavy oil using a slurry reactor by transferring a solid phase in the treated slurry to a liquid phase in order to leverage the advantages of upgrading heavy oil using slurry reactors while reducing two-phase flow problems such as negative impacts on the subsequent letdown process and thus reduce capital and operating costs.

In one aspect, there is provided a method of processing a treated feed slurry produced by a slurry reactor, comprising mixing a chemical separation feed with the treated feed slurry produced by the slurry reactor to chemically separate solid catalyst particles in the treated feed slurry by dissolving the solid catalyst particles using an acid or base in the chemical separation feed.

In another aspect, there is provided a heavy oil upgrading process comprising the above method

In yet another aspect, there is provided a system for processing a treated feed slurry produced by a slurry reactor, comprising: a source of chemical separation feed, the chemical separation feed comprising an acid or a base; and a connection to an output line exiting the slurry reactor to mix the chemical separation feed with the treated feed slurry in the output line to chemically separate solid catalyst particles in the treated feed slurry by dissolving the solid catalyst particles using an acid or base in the chemical separation feed.

In yet another aspect, there is provided a heavy oil upgrading facility comprising the system.

### BRIEF DESCRIPTION OF THE DRAWINGS

Embodiments will now be described with reference to the appended drawings wherein:

FIG. 1 is a block diagram illustrating an example of a heavy oil upgrading process using a slurry hydrocracking reactor.

FIG. 2 is a block diagram illustrating another example of a heavy oil upgrading process using a slurry hydrocracking reactor.

FIG. 3 is a flow chart illustrating operations performed in dissolving catalyst particles in a treated slurry from a slurry hydrocracking reactor.

FIG. 4 is a flow chart illustrating operations performed in a heavy oil upgrading process.

FIG. 5 is a schematic diagram of an example of a simulation for mixing an acid with an emulsion and a slurry hydrocracking reactor output.

### DETAILED DESCRIPTION

The following system and method address certain challenges in upgrading heavy oil using a slurry reactor by converting a solid phase in the treated slurry to a liquid phase in order to leverage the advantages of upgrading heavy oil using slurry reactors while reducing two-phase flow problems. In particular, this conversion from a solid phase to a liquid phase can mitigate negative impacts on the subsequent pressure letdown components, e.g., due to erosion in the letdown valve, and reduce capital and operating costs by eliminating the need for enhanced materials in the letdown system or the need to separate the solid catalyst from the treated slurry to avoid such negative impacts.

The product slurry from a slurry reactor can be converted from a solid phase to a liquid phase by using an acidic or basic agent to dissolve the solid catalyst instead of requiring physical separation of the catalyst particles from the slurry. Dissolving and leaching of the catalyst particles can be done at the reactor temperature or lower. The process of dissolving the solid catalyst particles and eliminating the solid phase can effectively convert a solid-liquid process to a liquid-liquid process and make solid handling less complicated and less capital intensive. While certain examples used herein refer to hydrocracking or hydro processing more generally, the principles discussed herein can also be applied to any slurry reactor in which a solid catalyst is used and can be dissolved as herein described.

A slurry hydrocracking process is used to improve heavy oil properties such as density and viscosity, as well as to remove impurities. Due to a high asphaltene content in heavy oil, hydrocracking catalysts are prone to deactivation. In a slurry reactor, solid catalyst particles are typically dispersed or mixed with heavy oil before being fed into the reactor. The hydrocracking reaction takes place in the reactor and the particles are suspended in the reactor according to the type of reactor being used, for example, by hydrogen flow (i.e., bubble flow) and physical mixing. After the hydrocracking reactions terminate, the solid catalyst and treated oil are discharged from the reactor and the catalyst dissolved or “chemically separated” as described below to convert the solid phase to a liquid phase and mitigate negative impacts downstream, in particular on the letdown system.

As will be described below, the process and system described herein can also be integrated with advanced oil recovery processes such as a steam assisted gravity drainage (SAGD) process, where a SAGD emulsion can be added instead of water to the treated slurry. Adding and treating emulsion reduces oil/water separation and water load. The raw bitumen in the SAGD emulsion can blend with the treated heavy oil which could also improve the stability of the treated heavy oil, which is not currently leveraged in heavy oil slurry reaction processes. In addition, the direct addition of wellhead emulsion assists in the entire SAGD heat integration and a portion of water can be converted to steam for the SAGD process, thus further leveraging available sources to integrate the chemical separation technique described herein.

Moreover, since most olefins are with the light hydrocarbon, the olefins in the light end could react with water (in the presence of acid as catalyst) and convert to alcohols (hydration reactions).

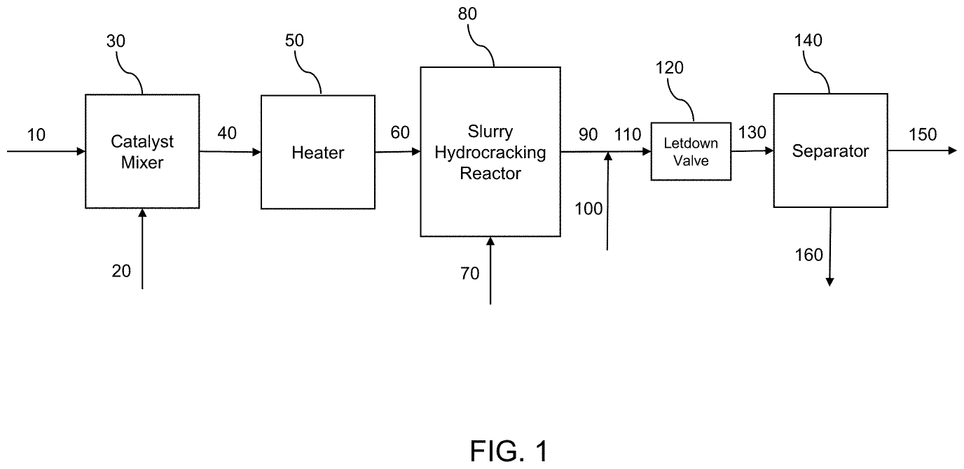

Referring now to the figures, FIG. 1 illustrates an example of a slurry hydrocracking process for partial upgrading of a heavy oil feedstock 10. The heavy oil feedstock 10 in this example is mixed or otherwise combined with a solid particulate catalyst 20 using a suitable catalyst mixer 30. Suitable catalysts 20 can include transitional metals, such as Fe, Ni, Co, Mo or a combination of these in an elemental state, as an oxide, sulfide, or sulfate. These metals (or combinations) can be supported on porous materials, such as alumina, silica, etc. The catalyst mixer 30 can be in the form of a stirred tank or other apparatus suitable for combining or introducing the catalyst into the heavy oil feedstock 10. The catalyst mixer 30 can be part of an upstream catalyst preparation phase, which may also include or otherwise be coupled to a catalyst sizing apparatus (not shown) for shaping catalytic material to a suitable size. For example, a suitable mill can be used to grind the catalytic material to a desired mean particle diameter. The catalyst preparation phase can also optionally include heating the heavy oil feedstock 10 to a free-flowing temperature (not shown) to reduce the initial viscosity of the feedstock 10 prior to being mixed with the catalyst 20.

The catalyst mixer 30 outputs a pumpable feed slurry 40. The feed slurry 40 is then fed to a heater 50 to heat the feed slurry 40 to a target reaction temperature for hydrocracking, for example by passing the feed slurry 40 through heating device(s) such as heat exchangers or a heater powered by a fuel or electricity. This results in a heated slurry 60 that is fed into a slurry hydrocracking reactor 80. The reactor 80 is also fed hydrogen 70 to perform the hydrocracking reaction. As indicated above, there are multiple types of slurry hydrocracking reactors 80, such as a stirred tank type reactor or a bubble column reactor, in which hydrogen is used to mix or suspend catalyst particles in the reactor 80.

The process described herein can be applied to either type of reactor 80 or any other slurry hydrocracking reactor 80 (or other slurry reactor) known in the art that produces a treated slurry 90 made up of treated oil with solid catalyst particles, which requires some form of separation to remove the solids from the treated oil. Normally, the treated slurry 90 would require a physical separation step, by settling, filtration, etc. In the process shown in FIG. 1, however, the solid catalyst in the treated slurry 90 is chemically separated using a feed that includes an acid or a base, referred to collectively as a “chemical separation feed 100”. In this example, the chemical separation feed 100 includes an acid or base and water; and is introduced, injected, combined or otherwise mixed with the treated slurry 90 to generate a mixture 110 that includes treated oil, dissolved catalyst particles and water.

The choice of acid or base for use in the chemical separation feed is generally dependent on the particular catalyst 20 being used, i.e., according to which acid or base most effectively dissolves the particular catalyst. However, for the purposes of illustration, suitable acids can include strong acids, such as, HCl, H₂SO₄, H₂S, HNO₃, and combinations thereof.

Similarly, while the choice of a suitable base will depend on the catalyst 20 being used, for the purposes of illustration, suitable bases can include strong bases, such as, NaOH, KOH, and combinations thereof.

It can be appreciated that the water used to introduce the acid or base can be provided from any available source. Advantageously, an emulsion that includes water can be combined with the acid or base to create the chemical separation feed 100. The emulsion would provide water to carry the acid or base and would also be lightened when combined with the treated oil in the slurry 90 to facilitate later separation, which is not currently leveraged in existing heavy oil upgrading processes. Moreover, lighter oil produced in the hydrocracking process may need to be blended with the emulsion to meet certain pipeline specifications. That is, the use of an emulsion rather than normal feedwater can be strategic as well as convenient. The emulsion can be obtained from an existing oil recovery site such as a SAGD operation. Other sources of water such as blowdown water or other recycled or reused water can be used, with suitable treatments applied if necessary. For example, SAGD boilers generate blowdown water, which is already basic and can be used for this purpose. It may be noted that any such source of water should be tested to ensure suitable reactivity, e.g., to determine if there are any species of concern in the water.

The treated slurry 90 exits the reactor 80 at a relatively high velocity. In existing systems, when the catalyst exits the reactor in solid form, this can cause major problems, such as erosion, when passing through a pressure letdown valve 120 used to reduce the pressure in the system. This problem is known in the art of heavy oil upgrading and has led to the use of expensive materials in the letdown system (e.g., enhanced erosion-resistant materials) or requires physical separation of the catalyst prior to passing through the letdown valve. In the present solution, by mixing the chemical separation feed 100 with the treated slurry 90 before the pressure letdown valve 120, the mixture 110 (which includes dissolved catalyst rather than solid particles) passes through the letdown valve 120. Since the mixture 110 includes dissolved catalyst (single phase) rather than suspended solid catalyst (two phase), the negative impacts on the pressure letdown valve 120 can be mitigated or even eliminated without the need for expensive materials or additional separation equipment. That is, the dissolved catalyst effectively converts the two phase (solid and liquid) treated slurry 90 to a single phase (liquid) or two-phase (liquid-liquid) mixture 110 to lessen the negative impacts on the letdown system. A letdown feed 130 may then be subjected to various downstream operations. For example, as shown in FIG. 1, the letdown feed 130 can be fed to a separator 140 to separate the water/emulsion, acid/base and dissolved particles, collectively the “separated feed 160” from the treated oil 150.

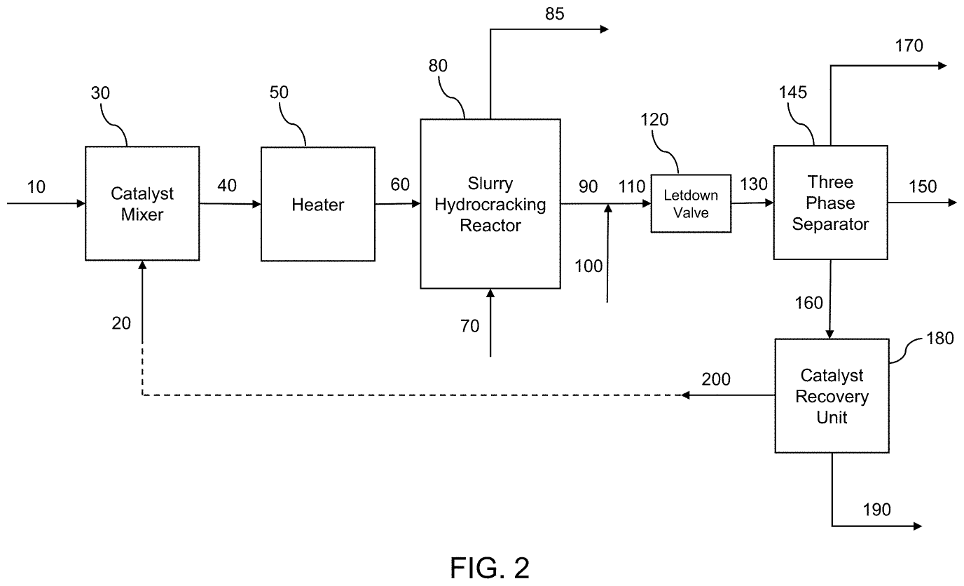

Referring now to FIG. 2, the process described above can also be adapted to include various other stages, examples of which are shown in FIG. 2 without limitation or exhaustion. In this example, light ends 85 can be separated directly from the reactor 80, which can be done to reduce the output volume and inhibit light ends from being mixed with steam in a later separation phase. As known in the art, heating heavy oil causes vapors to rise up through a tower, where they condense at various levels. Those that condense at the highest point are sometimes referred to as light ends 85, e.g., refinery gas, C3s or C4s. Also shown in FIG. 2, the process can be configured to use a three-phase separator 145 to generate steam 170 in addition to separating the separated feed 160 from the treated oil 150, to take advantage of the heat present in the system at this stage. It can be appreciated that after mixing water (e.g., SAGD emulsion) with the treated slurry 90 the stream has enough heat to convert (wholly or partially) water into steam, e.g., by flashing and dropping the pressure. The separated feed 160 which, as discussed above, includes water or emulsion, the acid or base and dissolved catalyst particles; can be fed to a catalyst recovery unit 180 to separate recovered catalyst 200 from the water or emulsion and the acid or base 190. It can be appreciated that the acid or base would tend to be partially neutralized in the process of dissolving the catalyst 20, but some further neutralization may be required prior to reuse or disposal of the water. The recovered catalyst 200 can be recycled and mixed with the catalyst 20 that is to be mixed with the heavy oil feedstock 10 as shown in dashed lines in FIG. 2.

It can be appreciated that other downstream processes can also be incorporated, such as recycling recovered hydrogen (not shown) and feeding the recycled hydrogen back to the reactor 80. For example, hydrogen that leaves the reactor with the light ends 85 can be separated from the light ends 85 then cleaned and reused.

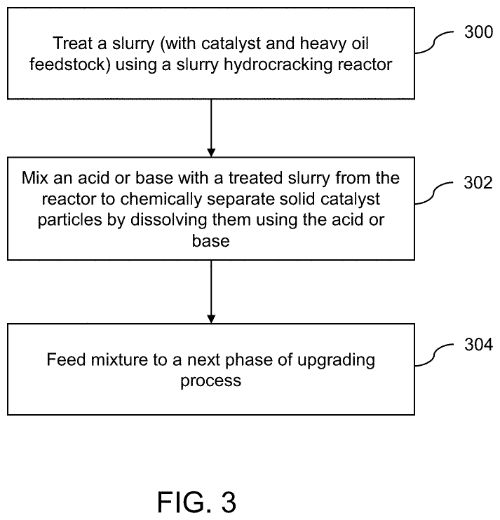

FIG. 3 is a flow chart illustrating operations performed in dissolving catalyst particles in a treated slurry 90 from a slurry hydrocracking reactor 80. At step 300 a feed slurry 40, 60, that includes a catalyst 20 mixed with a heavy oil feedstock 10, is treated using a slurry hydrocracking reactor 80. The slurry hydrocracking reactor 80 outputs a treated slurry 90 that includes treated oil and suspended solid catalyst particles. At step 302, an acid or base is mixed with the treated slurry 90 to chemically separate the solid catalyst particles from the treated oil by dissolving the solid catalyst particles using the acid or base. The acid or base can be mixed with the treated slurry 90 by introducing a water or emulsion carrying the acid or base, referred to above as the chemical separation feed 100. At step 304, the resulting mixture 110 can be fed to a next phase of the upgrading process, for example by reducing the pressure using the pressure letdown valve 120.

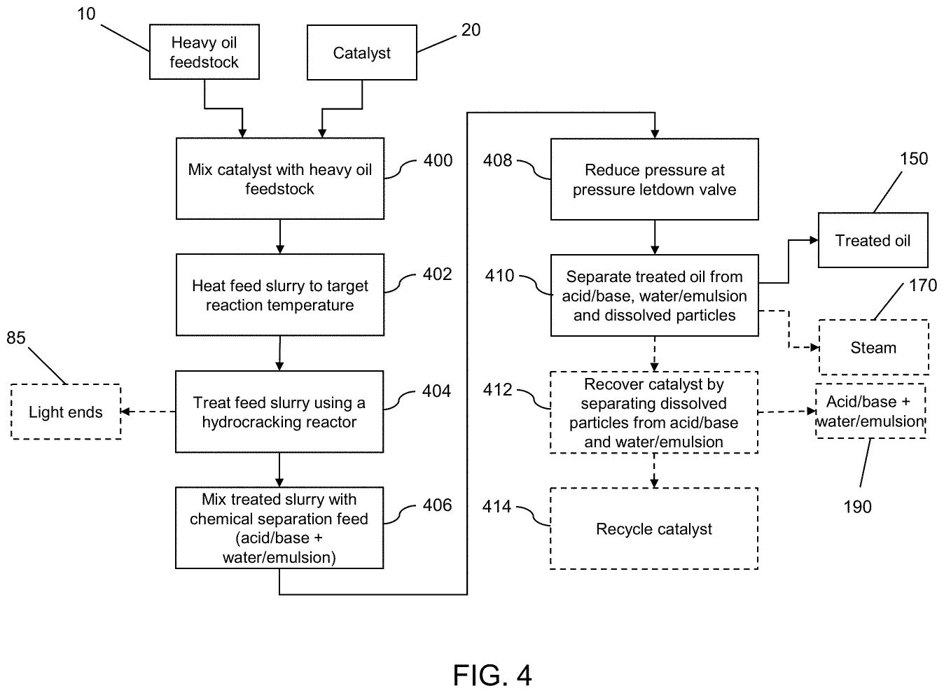

FIG. 4 is a flow chart illustrating operations performed in a heavy oil upgrading process, e.g., as shown in FIG. 1 or FIG. 2. At step 400, a catalyst 20 is mixed with a heavy oil feedstock 10, e.g., using a catalyst mixer 30, to produce a feed slurry 40. At step 402, the feed slurry 40 is heated, e.g., using a heater 50, to achieve a target reaction temperature. The heated feed slurry 60 is then fed to a slurry hydrocracking reactor 80 at step 404, to treat the heated feed slurry 60 and produce a treated slurry 90. Optionally, as shown in dashed lines, light ends 85 may also be captured from the reactor 80.

The treated slurry 90 is then mixed with a chemical separation feed 100 at step 406. As indicated above, the chemical separation feed 100 refers to a combination of an acid or base and water or an emulsion (containing water). This step chemically separates the solid catalyst particles suspended in the treated slurry 90 by dissolving the solid catalyst and effectively converting a solid-liquid two-phase feed into a liquid-liquid phase feed. By dissolving the catalyst particles at step 406 and prior to step 408, which reduces the pressure of the feed at a pressure letdown valve 120, issues normally associated with a slurry flow through such a letdown valve 120 can be mitigated.

At step 410, the treated oil 150 can be separated from the water/emulsion containing the acid/base, and the dissolved particles, to allow the treated oil to be transported or subsequently processed. Optionally, as shown in dashed lines, steam 170 can be generated, e.g., using a three-phase separator 145.

Steps 412 and 414 can also be optionally performed to recover the catalyst by separating the dissolved particles from the acid/base and water/emulsion at step 412 and recycling the recovered catalyst 200 at step 414.

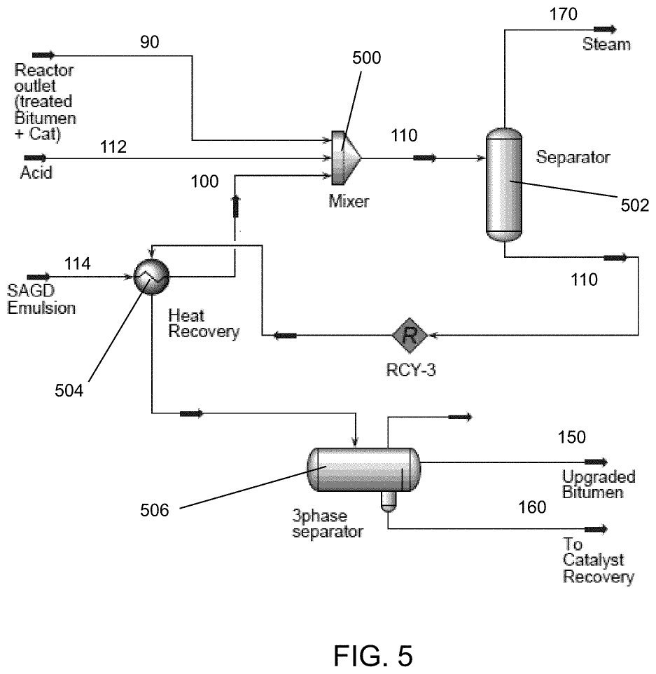

Turning now to FIG. 5, a schematic diagram showing an example of a modelling simulation of the configuration shown in FIG. 2, for mixing an acid or base with an emulsion and a treated slurry 90 to convert the two phase (solid and liquid) treated slurry 90 to a single phase (liquid) or two-phase (liquid-liquid) mixture 110 to lessen the negative impacts on the letdown system as described above. In this example simulation, the treated slurry 90 is fed to a mixer 500, where it is mixed with an acid feed 112 and a SAGD emulsion feed 114 (collectively the chemical separation feed 100 referred to above). The output of the mixer 500 corresponds to the mixture 110 referred to above. In this example, the mixture 110 is fed to a first separator 502 to generate steam 170 from the mixture 110. It can be appreciated that the first separator 502 would include an internal letdown valve not shown in the simulation diagram. The mixture 110 is then fed to a heat recovery unit 504 such as a heat exchanger to extract heat using the SAGD emulsion feed 114 as the cooling fluid for the heavy oil and to heat up the emulsion to evaporate water. The mixture 110 may then be fed to a second separator 506, in this example a three-phase separator, that separates the upgraded bitumen (referred to above as the treated oil 150) from the separated feed 160, which can be fed to a further stage (not shown) for catalyst recovery, e.g., as shown in FIG. 2. It can be appreciated that the separators 502 and 506 represent an implementation for the three-phase separator 145 shown in FIG. 2 and illustrate a configuration in which steps are added to perform heat recovery and to separate bitumen from water at a lower temperature.

Below is a series of tables illustrating example values used in the simulation shown in FIG. 5. It may be observed that for the reactor outlet the values shown for temperature and pressure (Table 1) are typical hydrocracking temperature and pressure values. Moreover, the reactor outlet value for mass flow (Table 1) was chosen arbitrarily for the purposes of the simulation. For the steam values (Table 2), the temperature and pressure values shown for steam correspond to typical temperature and pressure values used in SAGD. For Table 3, the SAGD emulsion values correspond to typical SAGD wellhead values.

TABLE 1
Reactor Outlet Values
Reactor Outlet (treated bitumen + catalyst)

| | | |
|---|---|---|
| Temperature | 430.0 | C. |
| Pressure | 1.500e+004 | kPa |
| Mass Flow | 1000 | kg/h |

TABLE 2
Steam Values
Steam

| | | |
|---|---|---|
| Temperature | 311.0 | C. |
| Pressure | 9970 | kPa |
| Mass Flow | 206.9 | kg/h |

TABLE 3
SAGD Emulsion Values
SAGD Emulsion

| | | |
|---|---|---|
| Temperature | 200.0 | C. |
| Pressure | 1.500e+004 | kPa |
| Mass Flow | 600 | kg/h |
| Comp Mass Flow (H₂0) | 402.76 | kg/h |

TABLE 4
Upgraded Bitumen Values
Upgraded Bitumen

| | | |
|---|---|---|
| Temperature | 254.9 | C. |
| Pressure | 9940 | kPa |
| Mass Flow | 1181 | kg/h |

TABLE 5
Catalyst Recovery Feed Values
To Catalyst Recovery

| | | |
|---|---|---|
| Temperature | 254.9 | C. |
| Pressure | 9940 | kPa |
| Mass Flow | 252.1 | kg/h |

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of processing a treated feed slurry produced by a slurry reactor, comprising:
mixing a chemical separation feed with the treated feed slurry produced by the slurry reactor to chemically separate solid catalyst particles in the treated feed slurry by dissolving the solid catalyst particles using an acid or base in the chemical separation feed.

2. The method of claim 1, wherein the chemical separation feed comprises water.

3. The method of claim 2, wherein the chemical separation feed comprises the acid or base and an emulsion, the emulsion comprising the water.

4. The method of claim 1, further comprising treating a feed slurry comprising a catalyst and a heavy oil feedstock using the slurry reactor; and adding the chemical separation feed to an output line of the slurry reactor to perform the mixing.

5. The method of claim 4, further comprising heating the feed slurry to a target reaction temperature prior to being fed to the slurry reactor.

6. The method of claim 1, further comprising feeding a mixture comprising treated oil, dissolved catalyst particles and the acid or base to a next phase of an upgrading process.

7. The method of claim 6, wherein the next phase comprises a pressure letdown phase.

8. The method of claim 1, wherein the slurry reactor is a hydrocracking type reactor.

9. The method of claim 8, wherein the slurry hydrocracking reactor is a bubble column reactor or an ebullated bed reactor.

10. The method of claim 1, wherein the acid is selected from HCl, H₂SO₄, H₂S, HNO₃, and combinations thereof and the base is selected from NaOH, KOH and combinations thereof.

11. A heavy oil upgrading process comprising the method of claim 1.

12. The process of claim 11, further comprising mixing a heavy oil feedstock with a catalyst to produce a feed slurry.

13. The process of claim 12, further comprising heating the heavy oil feedstock prior to mixing with the catalyst.

14. The process of claim 11, further comprising capturing light ends from the slurry reactor.

15. The process of claim 11, further comprising separating a mixture comprising treated oil, dissolved catalyst particles, the acid or base and water, at a separator downstream from the slurry reactor, to obtain treated oil and a separated feed comprising the dissolved catalyst particles, the acid or base and the water.

16. The process of claim 15, further comprising generating steam from the separator, the separator being a three-phase separator.

17. The process of claim 15, further comprising recovering catalyst from the separated feed by separating the dissolved catalyst particles from the acid or base and water.

18. The process of claim 17, further comprising recycling the recovered catalyst.

19. A system for processing a treated feed slurry produced by a slurry reactor, comprising:
a source of chemical separation feed, the chemical separation feed comprising an acid or a base; and
a connection to an output line exiting the slurry reactor to mix the chemical separation feed with the treated feed slurry in the output line to chemically separate solid catalyst particles in the treated feed slurry by dissolving the solid catalyst particles using an acid or base in the chemical separation feed.

20. A heavy oil upgrading facility comprising the system of claim 19 further comprising a separator to separate a mixture comprising treated oil, dissolved catalyst particles, the acid or base and water, at a separator downstream from the slurry reactor, to obtain treated oil and a separated feed comprising the dissolved catalyst particles, the acid or base and the water.
